(19) United States
(12) Patent Application Publication
(10) Pub. No.: US 2011/0290094 A1
(43) Pub. Date: Dec. 1, 2011

(54) AUTOMATIC PARALLEL ADJUSTING SCRAPER

(75) Inventor: BONG GU HEO, DAEGU (KR)

(73) Assignee: IST KOREA CO., LTD., DAEGU (KR)

(21) Appl. No.: 13/092,915

(22) Filed: Apr. 23, 2011

(30) Foreign Application Priority Data
May 25, 2010 (KR) 10-2010-0048557

(51) Int. Cl. B26D 3/06

(52) U.S. Cl. 83/875

(57) ABSTRACT

An automatic parallel adjusting scraper includes a drive-force generating part, a transmitting part, a hinge part and a scraping part. The drive-force generating part generates a first step drive force. The transmitting part is movably coupled to the drive-force generating part and transmits the first step drive force to the hinge part. The hinge part is rotatably coupled to the transmitting part and transmits the first step drive force to the scraping part. The scraping part having teeth is coupled to the hinge part. The scraping part is brought into parallel contact with a curved surface of a light guide plate by the first step drive force. Therefore, the automatic parallel adjusting scraper can precisely trace a three-dimensional curved surface of the light guide plate in two steps so that the optical scattering pattern can be continuously and precisely formed on the surface of the light guide plate.

### CROSS-REFERENCE TO RELATED APPLICATION AND CLAIM OF PRIORITY

This application claims the benefit of Korean Patent Application No. 10-2010-0048557 filed on May 25, 2010, in the Korean Patent and Trademark Office, the disclosures of which are incorporated herein in their entirety by reference.

### BACKGROUND OF THE INVENTION

1. Field of the Invention

The present invention relates generally to scrapers for scraping the surfaces of edge-type light guide plates to form optical scattering patterns.

2. Description of the Related Art

Information includes not only visual information but also auditory information, olfactory information, tactile information, etc.

Communicating information includes displaying the information to enable a desired person to recognize the information. The displaying is classified into a passive display method using a stationary visual medium, such as characters, pictures, marks, etc., for example, printed on paper, and an active display method, for example, using an LCD (liquid crystal display) or the like, which can communicate a large quantity of information using a variety of visual media including not only characters, pictures, marks, etc., but also light and video images.

CRT (cathode ray tube) displays and LCDs (liquid crystal displays) which are one kind of FPDs (flat panel displays) using TFT (thin film transistor) techniques are representative examples of such active displays.

Such LCDs have liquid crystals which are in an intermediate state between a solid and a liquid. The LCDs visually display information in such a way as to three-dimensionally control the orientation of liquid crystals so that reflection and transmission of light are controlled.

Furthermore, the LCDs control liquid crystals constituting each pixel in a digital manner. Therefore, they can provide more definite and clear image information. In addition, an area over which information is displayed can be comparatively increased by a lot, and the image quality is very much superior. Moreover, the LCDs have advantages of their weight, volume and power consumption being markedly reduced and having very superior mobility and portability.

However, unlike CRT (cathode ray tube) displays which are self emissive, the LCDs are non-emissive, so that a separate light source is required.

Depending on the method used to supply light, there is a light reflection method in which a light source is located in the front side of a display to supply light thereto, a light transmission method in which a light source is located in the rear side of a display to supply light thereto, and a hybrid method in which the light reflection method and a light transmission method are combined.

A light source device used in the light transmission method is called a back light unit (BLU), and a light source device used in the light reflection method is called a front light unit (FLU).

Particularly, BLUs are classified into a direct lighting BLU and an edge lighting BLU according to the method of positioning a light source.

Generally, a light source is a point light source. A line light source includes a plurality of point light sources which are arranged in a line. A surface light source includes a plurality of line light sources which are successively arranged in parallel.

The LCDs require such surface light sources. Particularly, in the case of LCDs using the light transmission methods, a surface light source requires a diffusion plate or light guide plate (hereinafter, referred to as a ‘light guide plate’) which evenly scatters light of a light source to provide uniform brightness to a comparatively wide display area.

In the following description, although the present invention will be illustrated as being applied to such light guide plates which scatter light of light sources over wide areas and the light guide plates will be illustrated as being used in LCDs, such LCDs are only one example, and the light guide plates can be used in a variety of electronic displays including the LCDs.

In the direct lighting BLUs, a plurality of light sources is disposed behind a light guide plate, thus forming a surface light source. The light guide plate scatters light to give it a uniform brightness and then supplies the light to a liquid crystal layer. In the edge lighting BLUs, a plurality of light sources is arranged in a line on an edge of a light guide plate. The light guide plate uniformly scatters light emitted from the light sources, thus converting the light sources into a surface light source before the light enters the liquid crystal layer.

As such, the BLUs typically include a light source, a light guide plate and a reflective plate.

In the edge lighting BLUs, light sources are disposed on an edge of a light guide plate. Thus, a relatively thin structure can be embodied, so that the edge lighting BLUs are mainly used in small, light and thin display devices, for example, portable display devices. On the other hand, in the direct lighting BLUs, because light sources are located behind the light guide plate, the thickness of a display using a direct lighting BLU is increased, but light efficiency is superior, so that the image quality of the display can be enhanced. Therefore, the direct lighting BLUs are mainly used in displays, such as monitors for TVs, which require large screens.

Typically, such light guide plates used in the edge lighting BLUs and in the direct lighting BLUs include an optical scattering pattern which is configured such that refraction, specular reflection, diffused reflection and diffraction of light emitted from the light sources are repeated to evenly scatter the light over the whole surface of the light guide plate and thus form a surface light source.

A screen printing method using ink mixed with resin, bead and adhesive is one representative example of conventional methods of forming optical scattering patterns on light guide plates.

However, it is difficult to uniformly repetitively print scattering patterns depending on conditions of resin or particles of beads which are mixed with ink, or a difference of the amount of adhesive mixed with ink, or conditions of the surface of the light guide plate. Thus, the number of defective products is increased.

Furthermore, in the case of a complex scattering pattern, ink may easily blur or overlap, thus deforming the pattern. Therefore, it is very difficult to form a surface light source having uniform brightness. With the lapse of time, a portion of the printed optical scattering pattern may be separated therefrom, resulting in a shortened lifespan.

As another method of forming optical scattering patterns, a technique of directly forming or shaping (hereinafter, referred to as “forming”) an uneven surface on the surface of the light guide plate using chemical corrosion or laser or mechanical machining is gaining in popularity. In the case of techniques using chemical corrosion or a laser, it is however difficult to precisely control the depth of the uneven surface, the forming process is comparatively complex, and expenses required to carry out the forming process are high.

Therefore, the technique used to form the optical scattering patterns has become focused on a technique wherein a scraper is used to mechanically and directly form an uneven surface on the surface of the light guide plate.

Meanwhile, the requirement that LCDs be light and thin has increased in order that the portability can be improved. Therefore, not only must the light guide plates also be thin but also the depths of the optical scattering patterns formed on the light guide plates must be very small.

Furthermore, the surfaces of the light guide plates must be very flat, yet they may be easily bent or curved by factors, such as gravity, etc. that occur during production, storage or forming.

It is very difficult to form an optical scattering pattern on a surface of a light guide plate to a uniform depth if the light guide plate is curved or bent and is thus not flat.

Moreover, when the optical scattering pattern is formed on a light guide plate that is not flat, the scattering pattern which must be continuously formed may be discontinuous on some portions of the light guide plate.

Therefore, an improved technique is required, which can use a mechanical scraper to form an optical scattering pattern on a light guide plate to a uniform depth even when the light guide plate is not flat.

Furthermore, a scraper is required, which can trace a three-dimensionally minutely curved surface of a light guide plate and scrape it to precisely form an optical scattering pattern on the light guide plate without the pattern being discontinuous.

### SUMMARY OF THE INVENTION

Accordingly, at least one embodiment of the present invention has been made keeping in mind the above problems occurring in the prior art, and an object of the present invention is to provide an automatic parallel adjusting scraper which can mechanically form an optical scattering pattern on a light guide plate to a uniform depth even when the light guide plate is not flat.

Another aspect of the present invention is to provide an automatic parallel adjusting scraper which can move along a three-dimensional curved surface of the light guide plate so that the optical scattering pattern can be continuously formed on the surface of the light guide plate.

A still another aspect of the present invention is to provide an automatic parallel adjusting scraper which can precisely trace along the curved surface of the light guide plate in two steps to continuously and uniformly form the optical scattering pattern on the surface of the light guide plate.

In order to accomplish the above one or more objects, the present invention provides an automatic parallel adjusting scraper which has a unit scraper, including: a drive-force generating part containing an elastic body therein, the drive-force generating part generating a first step drive force; a transmitting part coupled to the drive-force generating part so as to be movable, the transmitting part receiving the first step drive force from the drive-force generating part and transmitting the first step drive force; a hinge part rotatably coupled to the transmitting part, the hinge part receiving the first step drive force from the transmitting part and transmitting the first step drive force; and a scraping part coupled to the hinge part to receive the first step drive force from the hinge part, the scraping part having a plurality of teeth to form grooves of an optical scattering pattern in the light guide plate by the first step drive force, the scraping part being brought into parallel contact with a surface of a light guide plate, the hinge part rotating according to a shape of the light guide plate to make the teeth be in contact with the surface of the light guide plate even when the surface of the light guide plate is curved.

The automatic parallel adjusting scraper may further include a parallel-adjustment unit fastened to the transmitting part. The parallel-adjustment unit may include an elastic body and a parallel-adjustment rod and generate a second step drive force so that the teeth are brought into parallel contact with the curved surface of the light guide plate with a uniform pressure by the second step drive force.

The parallel-adjustment unit may include: a parallel-adjustment hole formed in a body of the transmitting part, the parallel-adjustment hole being completely open at a first end thereof and partially open at a second end thereof, with an internal thread formed on an inner surface of the parallel-adjustment hole; an elastic unit located in the parallel-adjustment hole to generate the second step drive force; a wing bolt engaging with the internal thread of the parallel-adjustment hole, the wing bolt retaining the elastic unit in the parallel-adjustment hole and adjusting a magnitude of the second step drive force; and the parallel-adjustment rod coupled into the partially open second end of the parallel-adjustment hole so as to be movable, the parallel-adjustment rod transmitting the second step drive force.

The parallel-adjustment unit may include one or more parallel-adjustment units provided in the transmitting part and oriented in one direction selected from between a horizontal direction and a vertical direction.

The drive-force generating part may include: a drive unit generating the first step drive force using the elastic body; a drive unit housing having an installation hole containing the drive unit therein, the installation hole being completely open at a first end of the drive unit housing, with an internal-thread formed on an inner surface of the installation hole, and a passing hole formed by partially opening a second end of the drive unit housing; and a stopper threaded with the internal thread of the drive unit housing to close the open end of the installation hole, the stopper retaining the drive unit in the installation hole and adjusting a magnitude of the first step drive force.

The transmitting part may include: a transmitting head inserted into the passing hole of the drive-force generating part so as to be movable, with a stop portion formed on the transmitting head so that the transmitting head is prevented from being removed from the drive-force generating part through the passing hole, the transmitting head receiving the first step drive force from the drive-force generating part; a transmitting rod fastened to the transmitting head, the transmitting rod receiving the first step drive force from the transmitting head and transmitting the first step drive force; and a coupling body fastened to the transmitting rod, the coupling body transmitting the first step drive force, the coupling body having a hinge receiving depression formed in a lower end of the coupling body so that the hinge part is rotatably coupled to the coupling body through the hinge receiving depression, and a hinge shaft hole formed through a sidewall of the coupling body which defines the hinge receiving depression.

The hinge receiving depression may form either a structure such that at least one sidewall of the coupling body is open or a structure such that no sidewall of the coupling body is open.

The hinge part may include a hinge shaft fitted into the hinge shaft hole of the transmitting part, and a hinge rod having a hinge hole into which the hinge shaft is rotatably inserted so that the hinge rod receives the first step drive force transmitted from the hinge shaft.

The automatic parallel adjusting scraper may further include a rod extension extending a predetermined length from the hinge rod in a direction away from the hinge hole.

The hinge hole may have one shape selected from among a circular shape, an elliptical shape and a triangular shape.

The hinge part may include one selected from between a hinge part having a single body and a hinge part divided on a medial portion thereof into two parts.

The scraping part may be rotatable within an angular range from +5° to −5° with respect to a central axis of the drive-force generating part so as to adjust a parallel status of the scraping part with respect to the light guide plate.

The pitches between adjacent teeth may be successively reduced from one end of the automatic parallel adjusting scraper to the other end thereof.

The automatic parallel adjusting scraper may include a plurality of unit scrapers arranged in a line to form a scraper assembly.

The scraper assembly may include a plurality of groups of unit scrapers, each group of the unit scrapers has the teeth with a same pitch, the plurality of groups have teeth with different pitches, and the groups of unit scrapers are arranged in a manner of a sequence from the group of unit scrapers having a largest pitch to the group of unit scrapers having a smallest pitch.

According to an aspect of the present invention, an automatic parallel adjusting scraper, which includes a unit scraper, the unit scraper includes: a drive-force generating part containing an elastic body therein, the drive-force generating part generating a first step drive force; a transmitting part coupled to the drive-force generating part so as to be movable, the transmitting part receiving the first step drive force from the drive-force generating part and transmitting the first step drive force; a hinge part rotatably coupled to the transmitting part, the hinge part receiving the first step drive force from the transmitting part and transmitting the first step drive force; a scraping part coupled to the hinge part to receive the first step drive force from the hinge part, the scraping part having a plurality of teeth to form grooves of an optical scattering pattern in the light guide plate by the first step drive force, the scraping part being brought into parallel contact with a surface of a light guide plate by a rotation of the hinge part even when the surface of the light guide plate is curved; and a parallel-adjustment unit horizontally fastened to the transmitting part, the parallel-adjustment unit generating a second step drive force so that the teeth are brought into parallel contact with the curved surface of the light guide plate with a uniform pressure by the second step drive force, the parallel-adjustment unit including: a parallel-adjustment hole formed in a body of the transmitting part, the parallel-adjustment hole being completely open at a first end thereof and partially open at a second end thereof, with an internal thread formed on an inner surface of the parallel-adjustment hole; an elastic unit located in the parallel-adjustment hole to generate the second step drive force; a wing bolt engaging with the internal thread of the parallel-adjustment hole, the wing bolt retaining the elastic unit in the parallel-adjustment hole and adjusting a magnitude of the second step drive force; and a parallel-adjustment rod coupled into the partially open second end of the parallel-adjustment hole so as to be movable, the parallel-adjustment rod transmitting the second step drive force.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view of a back light unit shown to illustrate the technique of the present invention;

FIG. 2 is a view illustrating the arrangement and construction of a light guide plate and a light source, according to an embodiment of the present invention;

FIG. 3 is a view illustrating the arrangement of a light guide plate and light sources, according to a modification of the embodiment of the present invention;

FIG. 4 is a view illustrating a method of scraping the surface of the light guide plate to form a scattering pattern according to the embodiment of the present invention;

FIG. 5 is a view showing an example of a deformed light guide plate;

FIGS. 6A through 6C are of sectional views showing other examples of deformed light guide plates;

FIG. 7 is a perspective view of a first embodiment of an automatic parallel adjusting scraper;

FIG. 8 is a sectional view showing the construction of the automatic parallel adjusting scraper according to the first embodiment of the present invention;

FIGS. 9A and 9B are of views showing examples of a hinge receiving depression of the automatic parallel adjusting scraper according to the embodiment of the present invention;

FIG. 10 is a sectional view showing the construction of a second embodiment of an automatic parallel adjusting scraper;

FIG. 11 is a sectional view showing the construction of a third embodiment of an automatic parallel adjusting scraper;

FIG. 12 is a sectional view showing an embodiment of a parallel-adjustment unit of the automatic parallel adjusting scraper according to the present invention;

FIGS. 13A through 13C are of views illustrating the operation of the automatic parallel adjusting scraper having a triangular hinge hole according to the present invention; and

FIG. 14 is a view showing the construction of a scraper assembly including a plurality of automatic parallel adjusting scrapers which are arranged in a line, according to an embodiment of the present invention.

### DETAILED DESCRIPTION

The terms and words used in the specification and claims are not necessarily limited to typical or dictionary meanings, but must be understood to indicate concepts selected by the inventor as the best method of illustrating the present invention, and must be interpreted as having meanings and concepts adapted to the scope and sprit of the present invention for understanding the technology of the present invention. In the following description, when it is determined that the detailed description for the conventional function and conventional structure confuses the gist of the present invention, the description may be omitted.

In the present invention, the term “parallel” means that a linear line defined by the surface of a light guide plate when it is at a preset correct position is parallel to a line connecting the tips of the teeth of a scraper to each other. Maintaining the parallel state is required to create a minute optical scattering pattern on the light guide plate that has a uniform and constant depth.

The term “automatic parallel adjustment” will be illustrated as meaning that the parallel is automatically adjusted on minute curved portion of the surface of the light guide plate which is brought into contact with the line connecting the tips of the teeth to each other.

Information is classified into visual information, auditory information, olfactory information and tactile information. Devices for displaying visual information are classified into emissive display devices, such as CRTs, which emit light by themselves, and non-emissive display devices, such as LCDs, which cannot emit light by themselves and use external light.

Non-emissive display devices need back light units (BLUs) for supplying light from the outside. The BLUs are classified into an edge lighting BLU which supplies light from the side edges of a display device and converts it into a surface light source, and a direct lighting BLU which supplies light from the entire area of a rear surface of a display device as a surface light source.

The term “effective area (effective screen)” refers to a region within which a user can effectively obtain visual information from a display unit, for example, an LCD, to which light is supplied from a back light unit as a surface light source.

The term “optical pattern” refers to a pattern which changes and controls a path of light in consideration of the fact that light is refracted, diffracted or reflected by a variety of scattering patterns.

The term “scattering pattern” refers to a pattern configured such that light is regularly or irregularly scattered over a desired region or portion using the optical pattern.

A scraper is a means for mechanically machining a target to form a selected pattern. The term “scraping” refers to machining the target using the scraper.

The term “assy” is an abbreviated form of “assembly” and refers to a component which is manufactured by assembling several parts that are different or the same with each other in a predetermined manner. Hereinafter, because scrapers each of which is standardized as a single unit (i.e., a unit scraper) are arranged in a line and then assembled into a single body, the term “assy” refers to a scraper assembly which is manufactured to have a predetermined length.

Springs provide moving force using the elasticity. There are many kinds of springs, for example, coil springs, plate springs, etc. Air cylinders generate a linear moving force using air. Oil cylinders generate a linear moving force using oil. Hereinafter, these cylinders will be described as being used as a power generating device or a drive unit.

A white point is a point which is brighter than other points or is uncontrollable in brightness under conditions of constant brightness on a surface light source. When this phenomenon is represented as a line, this is called a white line. A point which is darker than other points and is contrary to that of the white point is referred to as a black point. Typically, the black point phenomenon is induced by impurities, such as chips. Hereinafter, such black points will be illustrated as falling within the meaning of white points.

The term “surface-unit drive force” refers to a force or drive force to be transmitted through a surface having a predetermined size. The term “line-unit drive force” refers to a drive force that is transmitted through a line having a predetermined length. The term “point-unit drive force” refers to the drive force that is transmitted through a point having a predetermined size.

A pitch is a distance between adjacent valleys or the peaks of a screw or saw teeth. In the present invention, the term “pitch” will be represented in the drawings as the distance between adjacent peaks for the sake of the description. Furthermore, in a pattern having the same repetitive shapes, the term “pitch” refers to a distance between adjacent shaped portions.

Furthermore, in the description of the present invention, the terms “curve” and “inclination” will be used as having the same meaning, and an appropriate term will be selectively used depending on the context of a passage. The terms “flat”, “planar” and “level” will be generally used as having the same meaning, and the term “flat” will be mainly used.

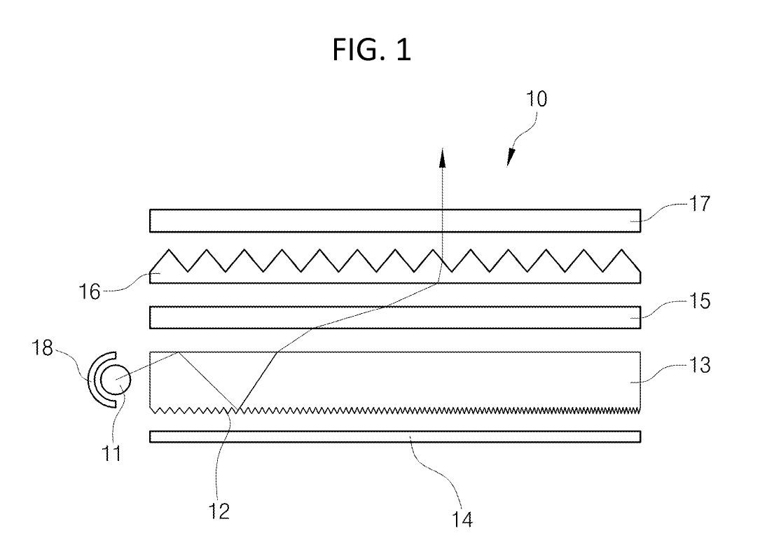

FIG. 1 is a sectional view of a back light unit shown to illustrate the technique of the present invention.

Hereinafter, the present invention will be described in detail with reference to the attached drawings. A back light unit 10 includes a light source 11, a light guide plate 13, a reflective sheet 14, a diffusion sheet 15, a prism sheet 16 and a DBEF (Dual Brightness Enhancement Film; 17). The light source 11 creates light and emits it. The light emitted from the light source 11 enters one edge of the light guide plate 13. The light guide plate 13 forms a surface light source using a scattering pattern 12 formed under a lower surface thereof so that the light that enters the light guide plate 13 is emitted therefrom in a light emitting manner of the surface light source. The reflective sheet 14 is provided under a lower surface of the light guide plate 13 to reflect light emitted through the lower surface of the light guide plate 13. The diffusion sheet 15 diffuses and disperses light emitted from an upper surface of the light guide plate 13 to make the brightness of the light uniform. The prism sheet 16 has a prism function which processes light that has passed through the diffusion sheet 15 such that the brightness of the light is increased on the front surface of the back light unit 10. The DBEF 17 protects the prism sheet 16 from external impact and is configured such that light that has passed through the prism sheet 16 passes through the DBEF 17 with reduced light loss. A reflector 18 is provided around the outside of the light source 11. The reflector 18 reflects light emitted from the light source 11 such that the light enters the edge of the light guide plate 13 without light leaking out.

In the back light unit 10 having the above-mentioned construction, light entering the edge of the light guide plate 13 from the light source 11 is repetitively total-reflected and refracted by the scattering pattern 12 to form the surface light source. Light which is emitted from the light guide plate 13 backwards is reflected by the reflective sheet 14 and thus goes towards the front surface of the back light unit 10.

The scattering pattern 12 is configured such that the pitch thereof is reduced in stages as it is farther away from the light source 11 to enhance the efficiency with which light is scattered. In other words, because light is more actively scattered as it goes farther away from the light source 11, the surface light source the brightness of which is uniform over the entire area thereof can be provided.

In the drawing, although the light source is illustrated as being provided on one edge of the light guide plate, light sources may be provided on respective both edges, all edges or a selected edge or edges of the light guide plate.

The surface light source that is formed by the above-mentioned method can be used in a flat panel display device, such as an LCD (liquid crystal display), which is non-emissive and is a light receiving style device, or in a lighting signboard, etc.

Screen printing, molding, cutting, etc. can be used as a method of forming the optical scattering pattern 12 in the light guide plate 13.

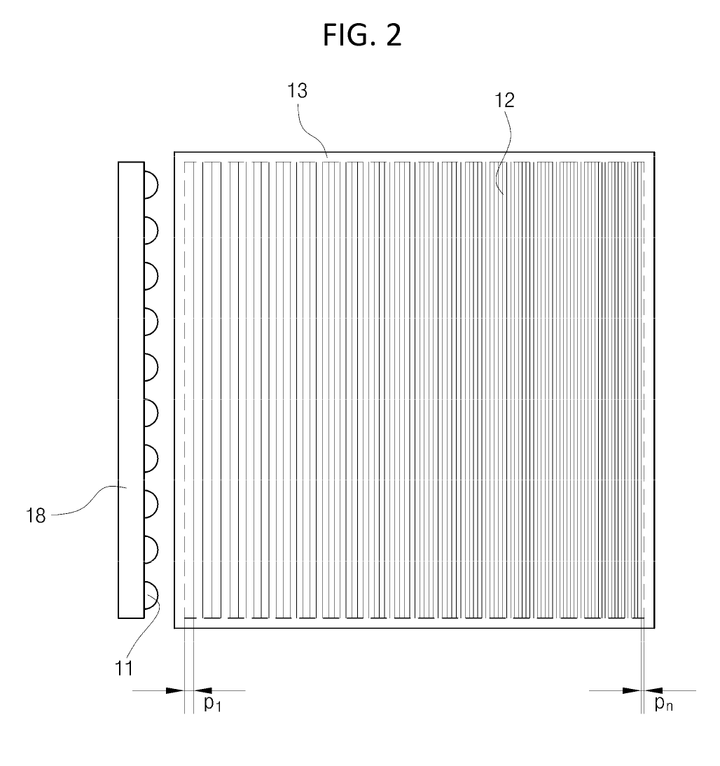

FIG. 2 is a view illustrating the arrangement and construction of the light guide plate and the light source according to the embodiment of the present invention.

Below these will be explained in detail with reference to FIG. 2. The reflector 18 is disposed on a corresponding side of the light source 11. The reflector 18 reflects light emitted from the light source 11 so that all of the light emitted from the light source 11 enters the edge of the light guide plate 13.

Light sources 11 may be disposed on both edges or all edges of the light guide plate 13. In this embodiment, the light source 11 is illustrated as being located on only one edge of the light guide plate 13.

The optical scattering pattern 12 formed on the corresponding surface of the light guide plate 13 is configured such that pitches p₁ through pₙ thereof become larger as they pass closer to the light source 11 while the pitches p₁ through pₙ become smaller as they go farther away from the light source 11.

The scattering pattern 12 may have a variety of shapes, for example, linear, oblique, wave, radial, Fresnel, etc. Furthermore, the scattering pattern 12 may have a shape deduced from these shapes, and two or more shapes may be combined to form the scattering pattern 12.

In the present invention, the scattering pattern is formed by cutting (hereinafter, referred to as ‘scraping’).

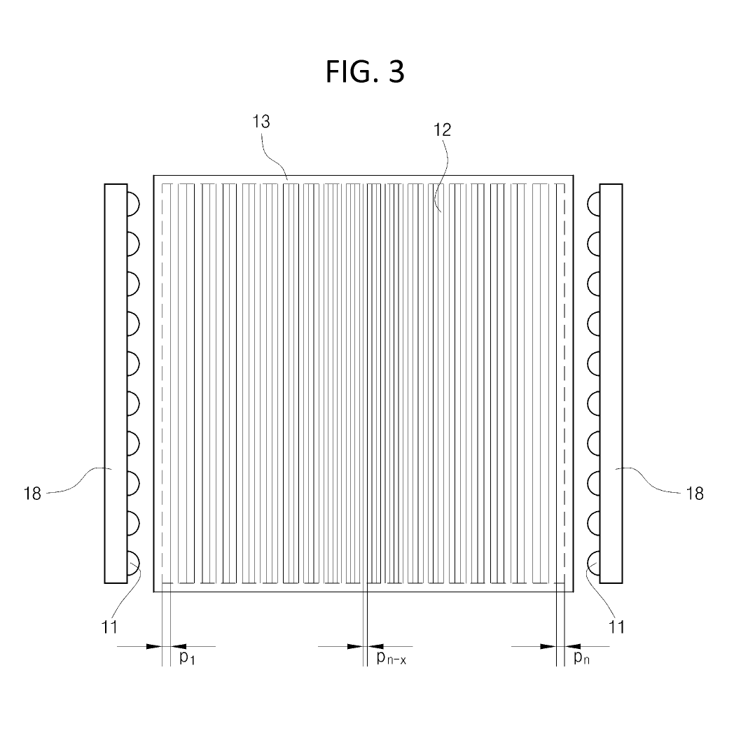

FIG. 3 is a view illustrating the arrangement of a light guide plate and light sources, according to another embodiment of the present invention.

Hereinafter, this will be explained in detail with reference to FIG. 3. In this embodiment, a light source 11 and a reflector 18 are located on each of opposite edges of the light guide plate 13. In this embodiment, light emitted from the light sources 11 enters the opposite edges of the light guide plate 13.

The optical scattering pattern 12 formed on the corresponding surface of the light guide plate 13 is configured such that the pitches p₁ and pₙ on the opposite edges of the light guide plate 13 which are adjacent to the respective light sources 11 are equal to each other and are largest, and the pitch pn-x of a medial portion of the light guide plate 13 which is farthest from the opposite light sources 11 is the smallest.

In the same manner, the scattering pattern 12 may adopt one or more selected from among a variety of shapes, for example, linear, oblique, wave, radial, Fresnel, etc. Preferably, the scraping method is used to form the scattering pattern 12 having a linear shape.

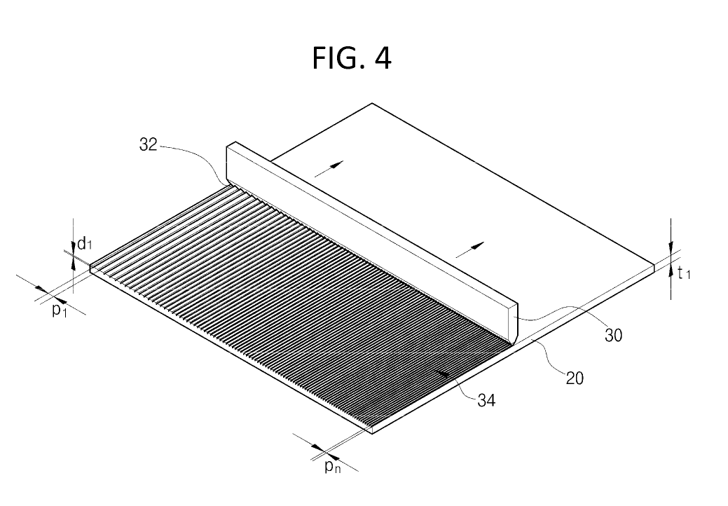

FIG. 4 is a view illustrating a method of scraping the surface of the light guide plate to form the scattering pattern according to the embodiment of the present invention.

Below this will be described in detail with reference to FIG. 4. A scraper 30 is located on one side of the corresponding surface of the light guide plate 20 which has a predetermined length and width and is planar or flat. Thereafter, the scraper 30 is linearly moved over the surface of the light guide plate 20 in the direction designated by the arrow.

A plurality of teeth 32 having certain pitches and depths is formed in a lower end of the scraper 30 which comes into contact with the surface of the light guide plate 20 while the scraper 30 moves over the light guide plate 20.

Each tooth 32 may have a circular or polygonal tip, preferably, a triangular tip.

Furthermore, the pitch p₁, pₙ which is a distance between adjacent teeth 32 may range from 0.2 mm to 2 mm.

In the embodiment, the pitch p₁ is largest, which is defined by the corresponding tooth 32 that forms the scattering pattern 34 on the portion of the light guide plate 20 that is closest to the light source. The pitch pₙ is smallest, which is defined by the corresponding tooth 32 that forms the scattering pattern 34 on the portion of the light guide plate 20 that is farthest from the light source.

The teeth 32 may have a predetermined depth d₁ such that valleys each of which has a depth d₁ ranging from 3 μm to 80 μm are formed in the light guide plate 20 by scraping.

The scraper 30 applies a predetermined pressure per unit area (kgf) to the light guide plate 20 in the vertical direction using a power generating device (not shown) and is linearly moved in the direction of the arrow along the surface of the light guide plate 20 by a linear moving unit (not shown). Therefore, the depth d₁ of the valleys of the scattering pattern 34 formed on the light guide plate 20 by scraping can be uniform.

In the drawings, the surface of the light guide plate 20 is illustrated as being ideally flat.

The light guide plate 20 has a thickness t₁ ranging from 1 mm to 4 mm, for example, of 2 or 3 mm.

Furthermore, the light guide plate 20 may be made of PMMA (poly-methyl-methacrylate) acryl resin.

In an embodiment, the light guide plate 20 is formed at a constant thickness t₁ by extruding PMMA acryl resin using an extrusion mold.

Here, the extruded light guide plate 20 may be easily deformed depending on various factors, for example, extrusion conditions, such as the temperature of the extrusion mold, the duration of extrusion, a period of extrusion, etc., the gravity applied thereto, tensile force applied to an extrudate, extrusion rollers for transferring the extruded light guide plate 20, the time taken to cool the extrudate, etc.

Furthermore, while the extruded light guide plate 20 which is relatively thin is placed and stored on a rack, the light guide plate 20 may be deformed depending on a variation in humidity or temperature of the storage place or a storage duration, or because the surface of the rack may be uneven.

Due to such a deformation, the light guiding plate 20 may be bent or the thickness thereof may be un-uniform, resulting in deteriorating flatness.

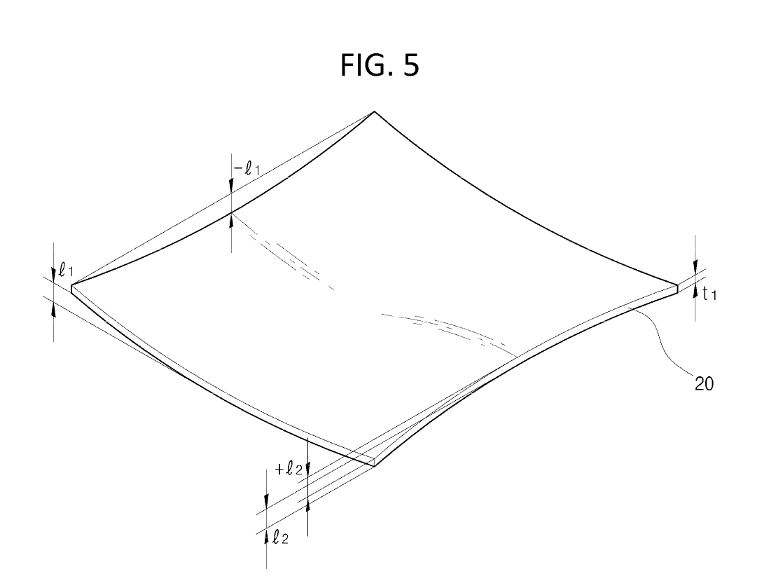

FIG. 5 is a view showing an example of a deformed light guide plate.

One example of the deformed light guide plate will be explained with reference to FIG. 5. The light guide plate 20 is formed by extruding a PMMA acryl resin plate having a thickness t₁ ranging from 1 mm to 4 mm using an extrusion mold. For example, the light guide plate 20 is formed using a plate having a thickness t of 3 mm.

PMMA acryl resin extruded from the extrusion mold is in a high-temperature semi-liquid state. While the extruded PMMA acryl resin passes through the extrusion rollers, the temperature thereof is reduced so that it is stabilized and solidified to form a plate to be used as the light guide plate 20.

Because the thickness t₁ of the light guide plate 20 which is being extruded in the semi-liquid state from the extrusion mold ranges from 1 mm to 4 mm, it may be easily deformed, for example, expanded, lumped, bent, etc., by a variety of factors, for example, extrusion conditions including the temperature of the extrusion mold and duration of extrusion, the time taken to cool the extruded light guide plate 20, the gravity, the humidity and temperature of a place where the extrusion is conducted, and conditions and surroundings of a place where the light guide plate 20 is placed and stored on the rack.

Even if such deformation is only very slight, the surface of the light guide plate 20 cannot become flat. If the degree of deformation is similar to or greater than the depth of the scattering pattern to be formed on the surface of the light guide plate 20, the formed scattering pattern may be defective, for example, a portion thereof may not be formed, in other words, the scattering pattern may be discontinuous.

As such, the light guide plate 20 formed in a rectangular shape having a predetermined size may be deformed; for example, it may be slightly uneven or be bent. Typically, the uneven or bent portions of the light guide plate 20 are subject to an error ranging from ±10 μm to ±150 μm, compared to the normal case which is ideally flat.

The depth of the grooves of the scattering pattern 34 which are formed by scraping the light guide plate 20 using the teeth 32 provided on the lower end of the scraper 30 ranges from 3 μm to 80 μm.

Therefore, in the case of the light guide plate 20 of the embodiment, the scattering pattern 34 cannot be normally formed on the portions on which height differences relative to the reference surface are induced, thus being defective.

For example, in the case of FIG. 5, when the opposite edges of the light guide plate 20 which is in the normal state are set as the reference, a medial portion of a left edge of the light to guide plate 20 sags downwards by a distance of −ρ₁ with respect to the reference. Thereby, the scattering pattern can be formed on both ends of the left edge but cannot be formed on the medial portion thereof, resulting in a defect that is discontinuous.

Furthermore, in the case of a right edge of the light guide plate 20, a medial portion protrudes upwards by a distance of +ρ₂. Therefore, the scattering pattern is formed only on the medial portion but cannot be formed on both ends thereof, or excessive pressure is applied to the medial portion, so that the scattering pattern may not be normally formed, thus resulting in a defect.

In the drawing, as one example, although the medial portion of each edge of the light guide plate 20 has been illustrated as sagging downwards by the distance of −ρ₁ or protruding upwards by the distance of +ρ₂ with respect to the opposite edges of the light guide plate 20 when the light guide plate 20 is in the normal state, some portions may be expanded and become thin or make a lump and become thick. It will be easily understood that these phenomena may be combined and the light guide plate 20 may be deformed in various shapes.

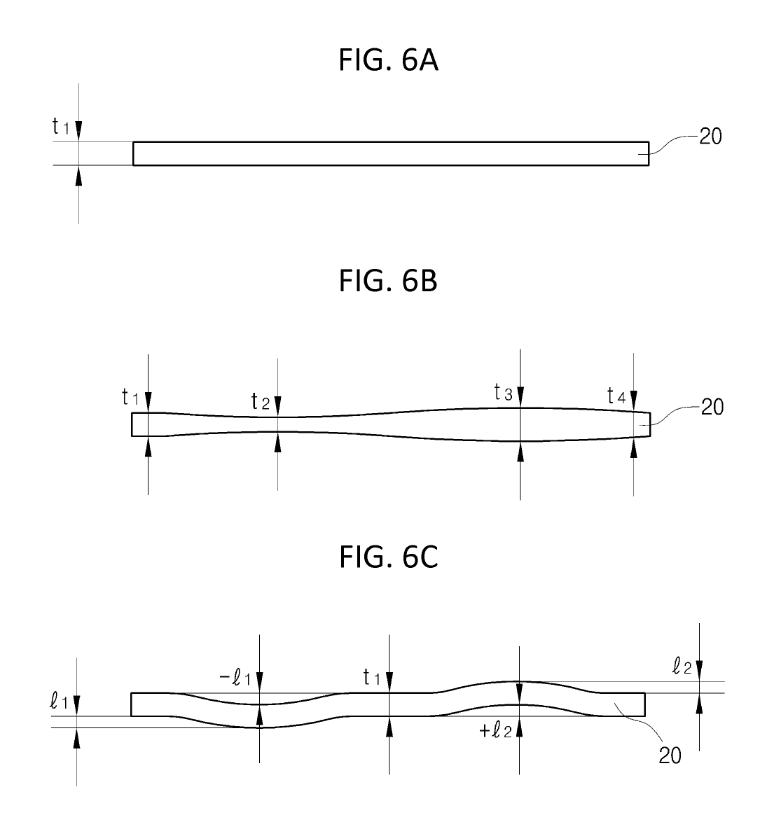

FIGS. 6A through 6C are of sectional views showing other examples of deformed light guide plates.

Referring to FIG. 6A, FIG. 6A illustrates a normal light guide plate 20 which is ideally flat and has a uniform thickness t₁.

However, actually, the thickness t of the extruded light guide plate 20 may be non-uniform, as shown in FIG. 6B.

In other words, when the light guide plate 20 is formed by extruding to have a thickness of t₁, a portion of the light guide plate 20 may have a thickness, for example, t₂, less than the thickness t₁, may have a thickness, for example, t₄, slightly greater than the thickness t₁, or may make a lump and thus have a thickness, for example, t₃, much greater than the thickness t₁ because of various reasons, such as gravity, extruding strength, tensile force, the temperature of the mold, etc., and depending on surrounding conditions. As such, the light guide plate 20 may be deformed and be non-uniform in thickness.

Furthermore, as shown in FIG. 6C, although the extruded light guide plate has a constant thickness of t₁, the light guide plate may be bent or curved so that its portions may become higher or lower than the reference surface.

In other words, the light guide plate 20 may be bent depending on extrusion conditions or storage conditions. A portion of the light guide plate 20 may be bent downwards by a distance of −ρ₁ or bent upwards by a distance +ρ₂. As such, the light guide plate 20 may not become level. That is, the light guide plate 20 may be deformed and thus become not flat

In the light guide plate 20 which is actually extruded and placed on the rack, styles of deformation shown by FIGS. 6B and 6C are combined so that it is very irregularly deformed.

If numerical values pertaining to such a deformation are greater than the depths of the grooves of the scattering pattern that range from 3 μm to 80 μm, the scattering pattern cannot be formed by scraping.

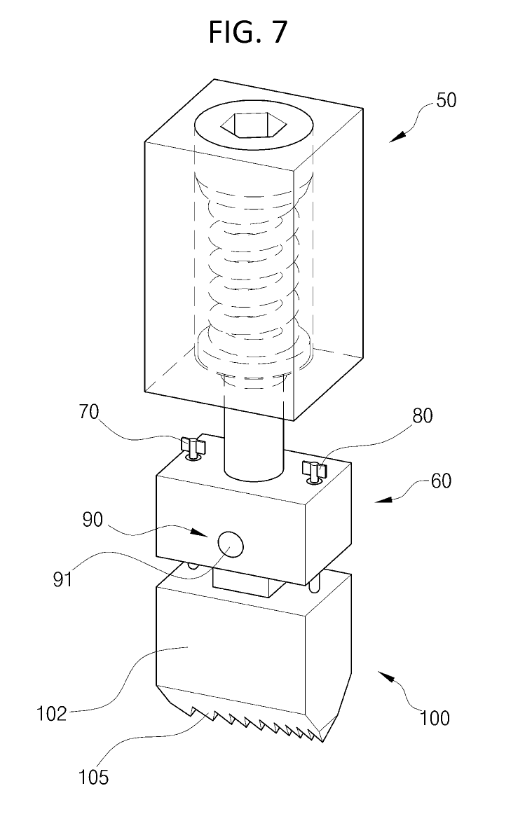

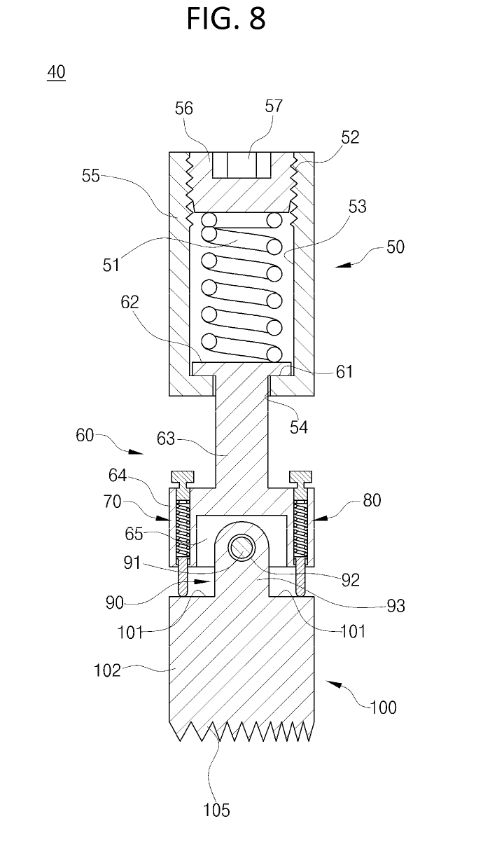

FIG. 7 is a perspective view of a first embodiment of an automatic parallel adjusting scraper. FIG. 8 is a sectional view showing the construction of the automatic parallel adjusting scraper according to the first embodiment of the present invention.

Hereinafter, the first embodiment will be explained in detail with reference to FIGS. 7 and 8. The automatic parallel adjusting scraper 40 includes a drive-force generating part 50, a transmitting part 60, a first parallel-adjustment unit 70, a second parallel-adjustment unit 80, a hinge part 90 and a scraping part 100.

The drive-force generating part 50 includes a drive unit 51, an internal thread 52, an installation hole 53, a passing hole 54, a drive unit housing 55, a stopper 56 and a screwdriver insert depression 57.

The drive unit 51 is installed in the installation hole 53 and generates drive force in the linear direction, for example, using elasticity. The drive unit 51 may include one selected from among a variety of drive-force generating devices including a coil spring, a plate spring, a rubber substance, an air cylinder, an oil cylinder, etc.

In the first embodiment shown by the drawings, a coil spring will be illustrated as being used as the drive unit 51.

The installation hole 53 contains the drive unit 51 therein and is completely open at a first end thereof which is oriented upwards. The internal thread 52 is formed on the inner surface of the open first end of the installation hole 53.

Furthermore, a second end (lower end) of the installation hole 53 is partially open only on a central portion thereof, thus forming the passing hole 54.

The drive unit housing 55 is a body which has the internal thread 52, the installation hole 53 and the passing hole 54 therein.

The stopper 56 functions to close the open first end of the installation hole 53. The stopper 56 is coupled to the drive unit housing 55 in such a way as to engage with the internal thread 52.

The screwdriver insert depression 57 is formed in the outer surface of the stopper 56, so that the stopper 56 can be threaded with the internal thread 52 or the depth to which the stopper 56 is inserted into the drive unit housing 55 can be adjusted by inserting a tool, such as a flathead, a cross-tip or hexagonal screwdriver, into the screwdriver insert depression 57 and rotating the tool in a desired direction.

As such, the stopper 56 is threaded-coupled with the internal thread 52 after the drive unit 51 is contained in the installation hole 53. Thereby, the drive unit 51 is prevented from being undesirably removed from the installation hole 53.

Furthermore, when the tool, such as a screwdriver, is inserted into the screwdriver insert depression 57 formed in the stopper 56 and is rotated in a clockwise or counterclockwise direction, the stopper 56 is moved along the thread so that the depth to which the stopper 56 is inserted into the drive unit housing 55 is adjusted. Thereby, the magnitude of elasticity of the drive unit 51 contained in the installation hole 53 can be adjusted. Therefore, the magnitude of a drive force (referred as “a first step drive force”) of the scraper can be controlled by adjusting the magnitude of the elasticity of the drive unit 51.

The linear drive force generated by the drive unit 51 enables the scraping part 100 to scrape the light guide plate in the optimal state to form an optical scattering pattern.

For example, in the case where the scraping part 100 has a width of 10 mm and ten teeth are provided on the scraping part 100, the depth to which the stopper 56 is threaded-coupled to the internal thread 52 is adjusted such that a drive force of 2 kgf is provided to the scraping part 100. According to an embodiment of the present invention, the drive force applied to the scraping part 100 is adjusted such that it is in direct proportion to the number of teeth.

In other words, if twenty teeth are provided on the scraping part 100, the drive unit 51 provides a drive force of 4 kgf. If thirty teeth are provided on the scraping part 100, the drive unit 51 provides a drive force of 6 kgf.

Due to the above-mentioned construction of the embodiment of the present invention, the drive-force generating part 50 can precisely trace the three-dimensional (3D) surface of the light guide plate.

The transmitting part 60 is movably coupled to the drive-force generating part 50 and transmits the drive force from the drive-force generating part 50 to the scraping part 100. The transmitting part 60 includes a stop portion 61, a transmitting head 62, a transmitting rod 63, a coupling body 64, a hinge receiving depression 65 and a hinge shaft hole 66.

The transmitting head 62 is integrated with a first end of the transmitting rod 63. A second end of the transmitting rod 63 is united with the coupling body 64 by welding or bonding, for example, by screw-coupling.

The transmitting head 62 is integrated with the transmitting rod 63 and is movably coupled to the drive-force generating part 50 while the transmitting rod 63 is inserted into the passing hole 54. The stop portion 61 prevents the transmitting head 62 from being removed out of the passing hole 54. The transmitting head 62 receives the drive force of the drive unit 51 and transmits it to the coupling body 64 through the transmitting rod 63.

In this embodiment, the first parallel-adjustment unit 70 and the second parallel-adjustment unit 80 are respectively provided on opposite lateral ends of the coupling body 64. The hinge receiving depression 65 is formed in the lower end of the coupling body 64.

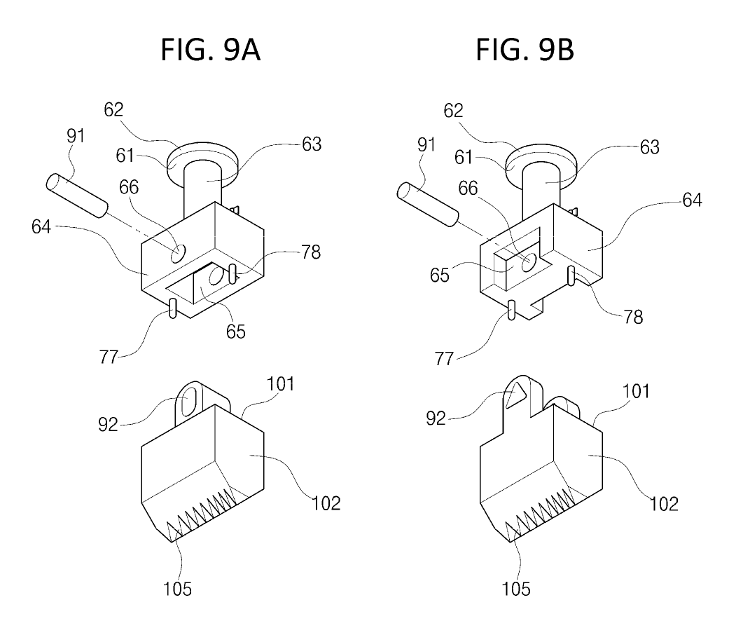

In this embodiment shown in FIGS. 8 and 9, although the coupling body 64 has been illustrated as having both the first parallel-adjustment unit 70 and the second parallel-adjustment unit 80, either or neither of them may be provided. This will be explained in detail later herein with reference to the corresponding drawings.

The hinge receiving depression 65 formed in the coupling body 64 forms either a structure such that the sidewall of the coupling body 64 is open or a structure such that it is not open. This will be explained in detail later herein with reference to the corresponding drawings.

The hinge shaft hole 66 is formed through the sidewall defining the hinge receiving depression 65.

The first parallel-adjustment unit 70 and the second parallel-adjustment unit 80 are respectively provided in the opposite lateral ends of the coupling body 64 of the transmitting part 60 and have the same construction and function. Each of the first and second parallel-adjustment units 70 and 80 includes a parallel-adjustment rod 77, 78 which is elastically movable, so that elastic drive force generated in the parallel-adjustment unit 70, 80 is outputted through the parallel-adjustment rod 77, 78. This will be explained in detail later herein with reference to the corresponding drawing.

The hinge part 90 is rotatably coupled to the transmitting part 60 to transmit drive force from the transmitting part 60 to the scraping part 100. The hinge part 90 includes a hinge shaft 91, a hinge hole 92 and a rotating rod 93.

The hinge shaft 91 is inserted into and fastened to the hinge shaft hole 66 of the transmitting part 60 and is rotatably inserted into the hinge hole 92.

In this embodiment, the hinge shaft 91 and the hinge hole 92 have diameters ranging from 3 mm to 4 mm. The hinge hole 92 has one shape selected from among a circular shape, an elliptical shape and a triangular shape. It will be explained later herein that the triangular shape is desirable.

The rotating rod 93 has the hinge hole 92 therein and transmits the drive force from the hinge shaft 91 to the scraping part 100.

In this embodiment of the attached drawings, although the hinge hole 92 is illustrated as having a circular shape, it may have an elliptical or triangular shape as another embodiment.

The scraping part 100 is coupled to the hinge part 90 and receives the drive force while the parallel status of the scraping part 100 is adjusted by the force of the parallel-adjustment unit 70 and 80. A plurality of teeth 105 is provided on the scraping part 100 within a standardized width at integer times. Thus, the teeth of the scraping part 100 scrape the light guide plate using the drive force, thus forming an optical scattering pattern on the light guide plate. The scraping part 100 includes a plurality of shoulders 101, a scraping part body 102 and the teeth 105.

The shoulders 101 come into contact with the parallel-adjustment rods 77 and 78 of the first and second parallel-adjustment units 70 and 80 so that the force used to adjust the parallel status of the scraping part 100 is directly applied from the parallel-adjustment rods 77 and 78 to the shoulders 101.

The scraping part body 102 converts the drive force transmitted from the rotating rod 93 into surface-unit drive force using the standardized width and area greater than the rotating rod 93 and then converts the surface-unit drive force into a line-unit drive force within the same width. The line-unit drive force is supplied to the teeth 105 which are arranged in a line on the lower end of the scraping part body 102.

The width w of the scraping part body 102 is preferably standardized within a range from 10 mm to 20 mm with an allowable error of a predetermined range (±).

The teeth 105 directly scrape the light guide plate to form the scattering pattern thereon. For example, ten teeth 105 are provided on the scraping part body 102 the width of which is standardized within the range from 10 mm to 20 mm.

The teeth 105 are formed to a predetermined depth and arranged at predetermined pitches.

In an embodiment, the teeth 105 may be arranged with a pitch p between adjacent teeth 105 ranging from 0.2 mm to 2 mm.

The pitches between each adjacent tooth 105 may be different from each other within a very small range of several or several tens of micrometers (μm).

Preferably, the pitches between adjacent teeth 105 are successively and slightly reduced from one end of the scraping part 100 to the other end thereof with respect to the lateral direction.

In the case where the teeth 105 are arranged at different pitches p, the width w of the standardized scraping part body 102 may be inconstant. Therefore, the number of teeth 105 is set on the basis of ten, and the width w of the standardized scraping part body 102 is set on the basis of the range from 10 mm to 20 mm and is allowed to vary within a predetermined error range (±).

The teeth 105 may be configured such that the same pitch is given as a unit of group. According to an embodiment of the present invention, each group has two or three adjacent teeth 105. Alternatively, all the teeth 105 provided on the standardized scraping part 100 may have the same pitch.

The depth defined by the teeth 105 is the same as the depth of the scattering pattern formed on the light guide plate and, for example, ranges from 3 μm to 80 μm.

In addition to the tracing by the drive-force generating part 50, the scraper according to the embodiment of the present invention can more precisely trace the three-dimensional surface of the light guide plate by a drive force (referred as “a second step drive force”), thanks to the above-mentioned structure including the first parallel-adjustment unit 70, the second parallel-adjustment unit 80, the hinge part 90 and the scraping part 100.

Therefore, the scraper according to the embodiment of the present invention can precisely trace the bent or curved surface of the light guide plate in double steps and thus continuously form minute grooves of the scattering pattern in the light guide plate without the scattering pattern being discontinuous.

FIGS. 9A and 9B are of views showing examples of the hinge receiving depression of the automatic parallel adjusting scraper according to the embodiment of the present invention.

This will be explained in detail with reference to FIGS. 9A and 9B. FIG. 9A illustrates a hinge receiving depression 65 formed in the coupling body 64 of the transmitting part 60 such that the sidewall of the coupling body 64 is not open, a rotating rod 93 inserted rotatably into the hinge receiving depression 65, and an elliptical hinge hole 92 formed through the rotating rod 93.

FIG. 9B illustrates a hinge receiving depression 65 formed in the coupling body 64 of the transmitting part 60 such that the sidewall of the coupling body 64 is open, a rotating rod 93 inserted rotatably into the hinge receiving depression 65, and a triangular hinge hole 92 formed through the rotating rod 93.

Although the hinge holes 92 of these examples have been illustrated as respectively having an elliptical shape and a triangular shape, the shape thereof is not limited to these, and it can have one shape such as a circular shape, an elliptical shape and a triangular shape.

Furthermore, it will be easily understood that various combinations can be deduced from the following options: the hinge receiving depression 65 is applied to either of structures in which the sidewall of the coupling body 64 is open or not; and the hinge hole 92 has one shape selected from among a circular shape, an elliptical shape and a triangular shape.

In addition, the hinge shaft hole 66 is formed in the coupling body, and the hinge shaft 91 is fitted into the hinge shaft hole 66 and the hinge hole 92.

In the case of the hinge receiving depression 65 that is open on the opposite sidewalls thereof, the rotating rod 93 that is rotatably coupled to the hinge receiving depression 65 may be divided on the medial portion thereof into two parts which are located on both sides and are symmetric with each other. In the case of the hinge receiving depression 65 that is not open on the opposite sidewalls thereof, the rotating rod 93 that is rotatably coupled to the hinge receiving depression 65 may have a single body which can be easily inserted into the hinge receiving depression 65.

The hinge shaft 91 is rotatably inserted into the hinge hole 92 formed through the rotating rod 93 having the above-mentioned structure.

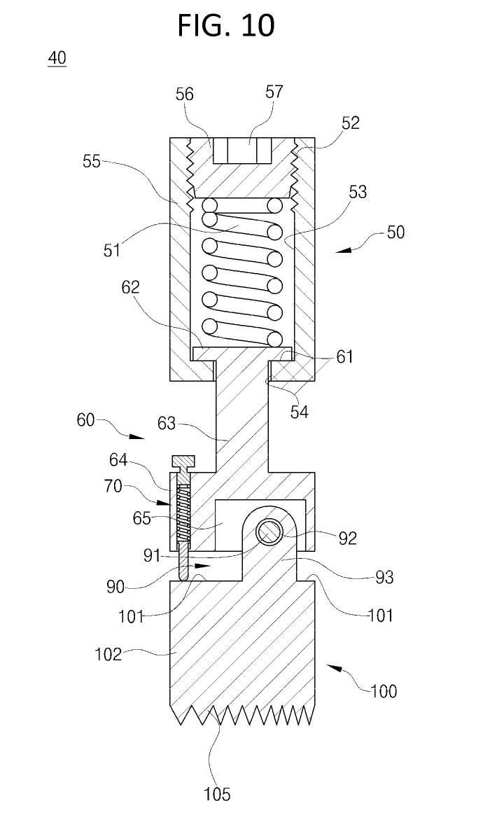

FIG. 10 is a sectional view showing the construction of a second embodiment of an automatic parallel adjusting scraper.

Referring to FIG. 10, in the second embodiment of the automatic parallel adjusting scraper, a hinge part 90 is located at a position away from the central portion of the transmitting part 60 rather than being located in the central portion of the transmitting part 60, unlike the construction of the embodiment of FIG. 8. The general construction of the second embodiment other than the above structure is the same as that of the embodiment of FIG. 8.

In FIG. 10, although the hinge part 90 is illustrated as being displaced to the right from the center of the automatic parallel adjusting scraper 40, it may displaced to the left.

In this case, the automatic parallel adjusting scraper 40 includes only one parallel-adjustment unit 70 which generates the force for making the scraping part 100 parallel to the surface of the light guide plate in a second step.

Alternatively, the automatic parallel adjusting scraper 40 may include only the hinge part 90 and have neither the first parallel-adjustment unit 70 nor the second parallel-adjustment unit 80, in the same manner as the first embodiment of FIG. 8.

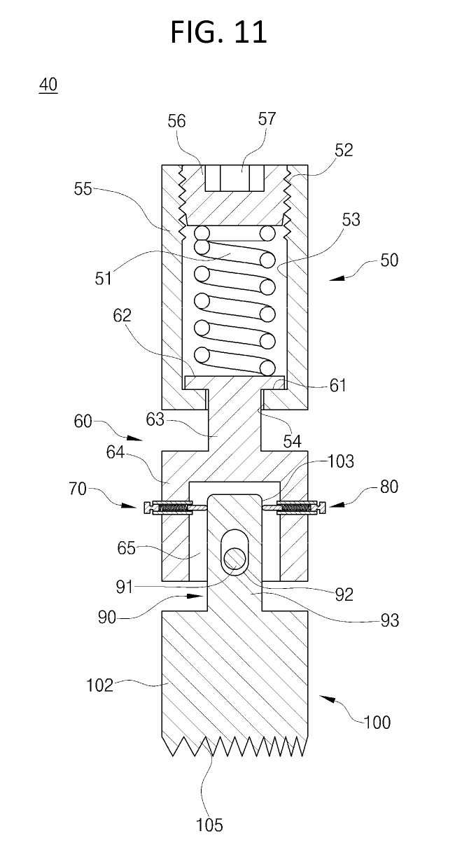

FIG. 11 is a sectional view showing the construction of a third embodiment of an automatic parallel adjusting scraper.

Referring to FIG. 11, unlike the construction of the embodiment of FIG. 8, a first parallel-adjustment unit 70 and a second parallel-adjustment unit 80 are oriented in the horizontal direction. Furthermore, a rotating rod 93 is longer than that of the embodiment of FIG. 8, so that a portion of the rotating rod 93 above the hinge hole 92 forms a rod extension 103, unlike the embodiment of FIG. 8. The general construction of the third embodiment other than the above-mentioned structure remains the same as that of the embodiment of FIG. 8.

In this embodiment, the first and second parallel-adjustment units 70 and 80 respectively come into contact with opposite sides of the end of the rod extension 103 so that the force for adjusting the parallel of the scraping part 100 is directly applied to the rotating rod 93.

As a modification of this embodiment, the rod extension 103 may include a plurality of rod extensions 103 which are separated from each other. In this case, a single first parallel-adjustment unit 70 and a single second parallel-adjustment unit 80 may be respectively provided on opposite sides of a selected at least one of the rod extensions 103. Alternatively, a plurality of first parallel-adjustment units 70 and a plurality of second parallel-adjustment units 80 may be provided on opposite sides of a selected at least one of the rod extensions 103.

As the distance from the center of the hinge shaft 91 to the upper end of the rod extension 103 increases and a length ratio of the distance between the center of the hinge shaft 91 and the upper end of the rod extension 103 to a distance from the center of the hinge shaft 91 to the teeth 105 increases, the force required by the first and second parallel-adjustment units 70 and 80 to adjust the parallel status of the scraping part 100 is reduced.

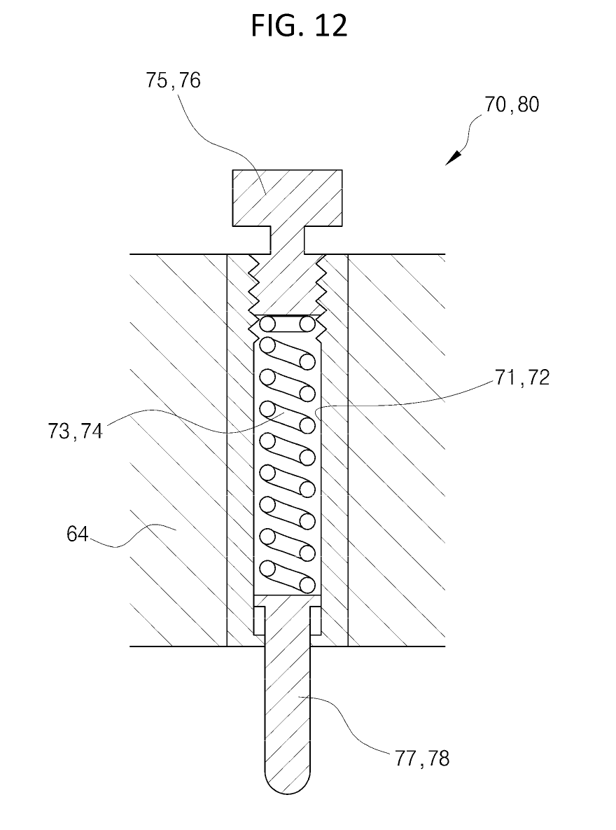

FIG. 12 is a sectional view showing an embodiment of the parallel-adjustment unit of the automatic parallel adjusting scraper according to an embodiment of the present invention.

Referring to the related drawings, the first and second parallel-adjustment units 70 and 80 respectively have parallel-adjustment holes 71 and 72 which are longitudinally formed through the opposite lateral ends of the coupling body 60.

Each parallel-adjustment hole 71, 72 is open at a first end thereof. An internal thread is formed on the inner surface of the open first end of the parallel-adjustment hole 71, 72. A second end of the parallel-adjustment hole 71, 72 is partially open.

Elastic units 73 and 74 are respectively installed into the parallel-adjustment holes 71 and 72. A wing bolt 75, 76 is threaded into the open threaded end of each parallel-adjustment hole 71, 72.

Each elastic unit 73, 74 may include one selected from among a variety of drive-force generating devices including a coil spring, a plate spring, a rubber substance, an air cylinder, an oil cylinder, etc.

Furthermore, each parallel-adjustment rod 77, 78 is inserted into the partially open second end of the corresponding parallel-adjustment hole 71, 72 and connected to the corresponding elastic unit 73, 74 so as to be elastically movable.

Each parallel-adjustment rod 77, 78 has a hemispheric end and comes into contact with the corresponding shoulder 101 of the scraping part 100.

The parallel-adjustment rods 77 and 78 generate, using the elastic units 73 and 74, a second step drive force for adjusting the parallel status of the scraping part 100. The generated drive force is applied to the shoulder 101 by the parallel-adjustment rods 77 and 78.

Due to such a construction of the first and second parallel-adjustment units 70 and 80, when the scraping part 100 which is rotatably coupled to the hinge part 90 comes into contact with the surface of the light guide plate, the scraping part 100 can adopt a parallel state. In other words, even when the scraping part 100 comes into contact with the curved portion of the light guide plate, the scraping part 100 can trace the curved surface of the light guide plate so that the scraping part 100 is maintained in the state of being parallel to the light guide plate.

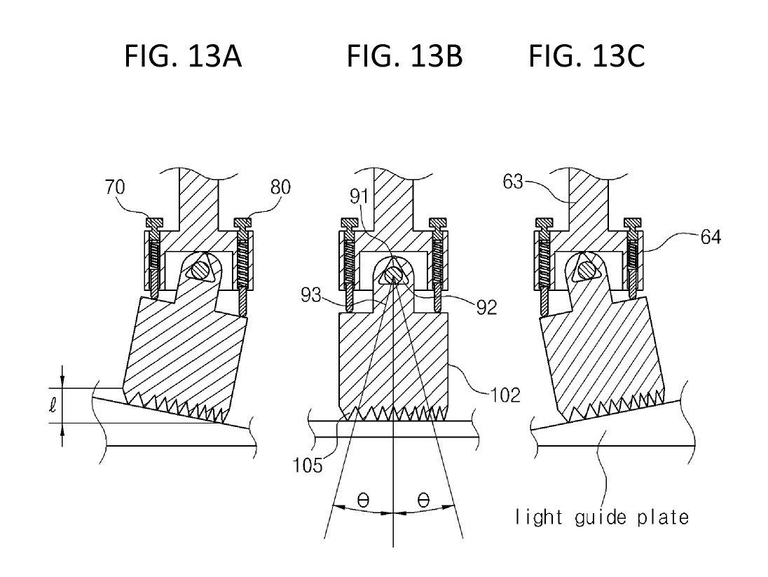

FIGS. 13A through 13C are of views illustrating the operation of the automatic parallel adjusting scraper having a triangular hinge hole according to an embodiment of the present invention.

This will be described in detail with reference to FIGS. 13A through 13C. FIGS. 13A through 13C illustrate the triangular hinge hole 92 of the hinge part 90 as one embodiment

In this embodiment, although the hinge hole 92 is illustrated as having a triangular shape, it will be easily understood that it may have not only a triangular shape but also, for example, a circular shape or an elliptical shape.

FIG. 13A shows the case where a portion of the surface of the light guide plate is inclined or curved downwards to the right, and the scraping part 100 traces the corresponding portion of the surface of the light guide plate using the first parallel-adjustment unit 70 and the second parallel-adjustment unit 80.

In other words, the scraping part 100 including the scraping part body 102 and the teeth 105 is also inclined to the right at the same angle as that of the surface of the light guide plate that is inclined or curved downwards to the right

As such, because the line connecting the tips of the teeth 105 of the scraping part body 102 to each other comes into parallel contact with the line defined by the corresponding curved or inclined portion of the surface of the light guide plate when viewed in the sectional view, all the teeth 105 can uniformly come into contact with the curved or inclined surface of the light guide plate.

In the state of FIG. 13A, the portion forming the left vertex of the triangular hinge hole 92 stably supports the hinge shaft 91 such that the teeth 105 provided on the end of the scraping part body 102 can come into parallel with the rightward-inclined surface of the light guide plate so that the drive force of the drive-force generating part can be reliably transmitted to the surface of the light guide plate.

Therefore, an optical scattering pattern can be precisely and uniformly formed on the surface of the light guide plate despite the fact that it is inclined or curved downwards to the right.

FIG. 13B shows the case where the scraping part 100 having the scraping part body 102 and the teeth 105 comes into parallel contact with a horizontal portion of the surface of the light guide plate.

In this case, the portion forming the upper vertex of the triangular hinge hole 92 stably supports the hinge shaft 91 such that the teeth 105 can come into parallel with the surface of the light guide plate so that a minute optical scattering pattern can be precisely and uniformly formed on the surface of the light guide plate by the drive force of the drive-force generating part.

FIG. 13C shows the case where a portion of the surface of the light guide plate is inclined or curved downwards to the left, and the scraping part 100 is also inclined at the corresponding angle such that the scraping part 100 comes into parallel contact with the inclined or curved portion of the light guide plate.

In other words, the scraping part 100 traces the inclined or curved surface of the light guide plate using the first parallel-adjustment unit 70 and the second parallel-adjustment unit 80 so that it can come into parallel contact with the light guide plate.

In this case, the portion forming the right vertex of the triangular hinge hole 92 stably supports the hinge shaft 91 such that the teeth 105 can come into parallel with the leftward-inclined surface of the light guide plate so that the drive force of the drive-force generating part can be reliably transmitted to the surface of the light guide plate. Thereby, a minute optical scattering pattern can be precisely and uniformly formed on the surface of the light guide plate.

For example, the angle to which the scraping part 100 is inclined to the left or right ranges from +5° to −5°.

As such, the scraping part 100 of an embodiment of the present invention having a width ranging from 10 mm to 20 mm can trace the surface of the light guide plate such that the scraping part 100 is parallel to the surface of the light guide plate, even if it is curved within a height ρ of 0.001 mm. Therefore, a minute scattering pattern can be precisely formed on the light guide plate without being discontinuous.

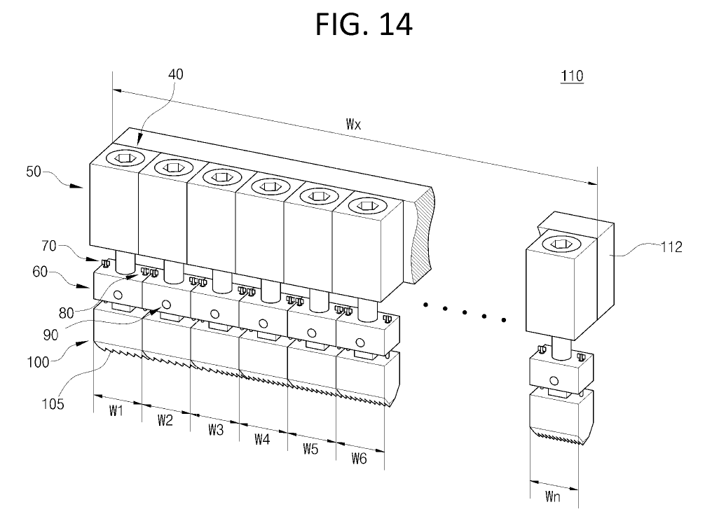

FIG. 14 is a view showing the construction of a scraper assembly including a plurality of automatic parallel adjusting scrapers which are arranged in a line, according to an embodiment of the present invention.

Referring to FIG. 14, the scraper assy 110 according to the present invention includes the standardized automatic parallel adjusting scrapers 40 which are continuously arranged in a line, and a mounting member 112 to which the automatic parallel adjusting scrapers 40 are fastened.

The scraper assy 110 can be moved upwards, downwards, leftwards or rightwards by a separate drive device (not shown).

The standardized automatic parallel adjusting scrapers 40 of the scraper assy 110 have teeth 105 the pitches of which are successively increased or reduced.

In this embodiment, as shown in the drawing, the pitch p is successively reduced from a leftmost tooth 105 of a first automatic parallel adjusting scraper 40 having a first unit width w1 to a rightmost tooth 105 of an automatic parallel adjusting scraper 40 having an n-th unit width wn via a second automatic parallel adjusting scraper 40 having a second unit width w2, a third automatic parallel adjusting scraper 40 having a third unit width w3 and so on.

Here, the opposite ends of the scraping part 100 of each automatic parallel adjusting scraper 40 coincide with the bottoms of the corresponding valleys of the teeth 105. Thus, the sum of pitches of the teeth 105 of each automatic parallel adjusting scraper 40 is the same as the width w of the automatic parallel adjusting scraper 40.

Therefore, the first unit width w1, the second unit width w2, the third unit width w3 and the n-th unit width wn of the scraper assy 110 may differ from each other within the minimum error range defined by the absolute value.

Furthermore, each standardized automatic parallel adjusting scraper 40 of the scraper assy 110 has the drive unit 51 of the drive-force generating part 50 which is configured such that the magnitude (kgf) of the drive force generated by the drive unit 51 is in direct proportion to the number of teeth 105.

In other words, regardless of the number of teeth 105, each automatic parallel adjusting scraper 40 is configured such that a uniform magnitude of drive force is applied to each tooth 105.

The pitch of the portion of the scattering pattern that is formed on the light guide plate at a position closest to the light source must have the maximum value within an allowed range. The pitch of the corresponding tooth 105 must be the largest, and the pitch of the teeth 105 is successively reduced as the location thereof moves farther away from the light source.

The reason for why the pitches of teeth 105 differ from each other is that because the brightness of light entering a portion of the light guide plate which is adjacent to the light source is comparatively high, the degree of scattered light must be reduced, and because the brightness of light entering a portion of the light guide plate which is far from the light source is comparatively low, the degree of scattered light must be increased, so that a surface light source having uniform brightness over the whole can be formed.

Therefore, in the scraper assy 110, the automatic parallel adjusting scraper 40 that forms a portion the scattering pattern which is farthest from the light source has the smallest pitch within an allowance range. The automatic parallel adjusting scraper 40 that forms a portion the scattering pattern which is nearest to the light source has the largest pitch within the allowance range.

As the pitch between adjacent teeth 105 increases, the number of teeth 105 provided on the standardized automatic parallel adjusting scraper 40 is reduced. As the pitch between adjacent teeth 105 is reduced, the number of teeth 105 increases. Preferably, the number of teeth 105 is determined within a range of ten such that an error of the standardized width of the automatic parallel adjusting scraper 40 is minimized.

In the present invention, the allowed value of the pitch of the adjacent teeth 105 ranges from 0.2 mm to 2 mm.

Alternatively, as the design of the optical scattering pattern, pitches P of each automatic parallel adjusting scraper 40 may be set as a unit of group such that the pitches P of the groups are successively reduced or increased.

Furthermore, the teeth 105 may be arranged such that values of pitches alternate or are regularly or irregularly combined. As a further alternative, the teeth 105 may be arranged such that the pitch of the medial portion of the light guide plate is smallest and the pitches of portions adjacent to both edges of the light guide plate are the largest or are formed in a reverse manner.

Moreover, two or more of these several arrangement methods may be combined.

It is desirable that the teeth 105 apply uniform pressure to the light guide plate using a drive force to form the optical scattering pattern having grooves with depths ranging from 3 μm to 80 μm in the light guide plate.

The entire width wx of the scraper assy 110 may be changed depending on the size of the light guide plate on which an optical scattering pattern is formed and, preferably, ranges from 200 mm to 820 mm Moreover, it may be extended to a length greater than 1000 mm.

As described above, an automatic parallel adjusting scraper according to the present invention can mechanically scrape a light guide plate to form a minute optical scattering pattern on the light guide plate to a uniform depth even when the light guide plate is not flat.

Furthermore, the automatic parallel adjusting scraper can precisely trace a three-dimensional curved surface of the light guide plate so that the optical scattering pattern can be continuously and precisely formed on the surface of the light guide plate.

Moreover, the automatic parallel adjusting scraper can precisely trace the curved or bent surface of the light guide plate in two steps to continuously and uniformly form the optical scattering pattern on the surface of the light guide plate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An automatic parallel adjusting scraper, comprising a unit scraper comprised of
a drive-force generating part containing an elastic body therein, the drive-force generating part generating a first step drive force;
a transmitting part coupled to the drive-force generating part so as to be movable, the transmitting part receiving the first step drive force from the drive-force generating part and transmitting the first step drive force;
a hinge part rotatably coupled to the transmitting part, the hinge part receiving the first step drive force from the transmitting part and transmitting the first step drive force; and
a scraping part coupled to the hinge part to receive the first step drive force from the hinge part, the scraping part having a plurality of teeth to form grooves of an optical scattering pattern in the light guide plate by the first step drive force, the scraping part being brought into parallel contact with a surface of a light guide plate, the hinge part rotating according to a shape of the light guide plate to make the teeth be in contact with the surface of the light guide plate even when the surface of the light guide plate is curved.

2. The automatic parallel adjusting scraper as set forth in claim 1, further comprising:
a parallel-adjustment unit fastened to the transmitting part, the parallel-adjustment unit generating a second step drive force so that the teeth are brought into parallel contact with the curved surface of the light guide plate with a uniform pressure by the second step drive force.

3. The automatic parallel adjusting scraper as set forth in claim 2, wherein the parallel-adjustment unit comprises:
a parallel-adjustment hole formed in a body of the transmitting part, the parallel-adjustment hole being completely open at a first end thereof and partially open at a second end thereof, with an internal thread formed on an inner surface of the parallel-adjustment hole;
an elastic unit located in the parallel-adjustment hole to generate the second step drive force;
a wing bolt engaging with the internal thread of the parallel-adjustment hole, the wing bolt retaining the elastic unit in the parallel-adjustment hole and adjusting a magnitude of the second step drive force; and
a parallel-adjustment rod coupled into the partially open second end of the parallel-adjustment hole so as to be movable, the parallel-adjustment rod transmitting the second step drive force.

4. The automatic parallel adjusting scraper as set forth in claim 3, wherein the parallel-adjustment unit comprises a single parallel-adjustment unit provided in the transmitting part and oriented in one direction selected from between a horizontal direction and a vertical direction.

5. The automatic parallel adjusting scraper as set forth in claim 3, wherein the parallel-adjustment unit comprises at least two parallel-adjustment units provided in the transmitting part and oriented in one direction selected from between a horizontal direction and a vertical direction.

6. The automatic parallel adjusting scraper as set forth in claim 1, wherein the drive-force generating part comprises:
a drive unit generating the first step drive force using the elastic body;
a drive unit housing having:
an installation hole containing the drive unit therein, the installation hole being completely open at a first end of the drive unit housing, with an internal-thread formed on an inner surface of the installation hole; and
a passing hole formed by partially opening a second end of the drive unit housing; and
a stopper threaded with the internal thread of the drive unit housing to close the first end of the installation hole, the stopper retaining the drive unit in the installation hole and adjusting a magnitude of the first step drive force.

7. The automatic parallel adjusting scraper as set forth in claim 1, wherein the transmitting part comprises:
a transmitting head inserted into the passing hole of the drive-force generating part so as to be movable, with a stop portion formed on the transmitting head so that the transmitting head is prevented from being removed from the drive-force generating part through the passing hole, the transmitting head receiving the first step drive force from the drive-force generating part;
a transmitting rod fastened to the transmitting head, the transmitting rod receiving the first step drive force from the transmitting head and transmitting the first step drive force; and
a coupling body fastened to the transmitting rod, the coupling body transmitting the first step drive force, the coupling body having:
a hinge receiving depression formed in a lower end of the coupling body so that the hinge part is rotatably coupled to the coupling body through the hinge receiving depression; and
a hinge shaft hole formed through a sidewall of the coupling body which defines the hinge receiving depression.

8. The automatic parallel adjusting scraper as set forth in claim 7, wherein at least one sidewall of the coupling body is open.

9. The automatic parallel adjusting scraper as set forth in claim 7, wherein no sidewall of the coupling body is open.

10. The automatic parallel adjusting scraper as set forth in claim 7, wherein the hinge part comprises:
a hinge shaft fitted into the hinge shaft hole of the transmitting part; and
a hinge rod having a hinge hole into which the hinge shaft is rotatably inserted so that the hinge rod receives the first step drive force transmitted from the hinge shaft.

11. The automatic parallel adjusting scraper as set forth in claim 10, further comprising:
a rod extension extending a predetermined length from the hinge rod in a direction away from the hinge hole.

12. The automatic parallel adjusting scraper as set forth in claim 11, wherein the hinge hole has one shape selected from among a circular shape, an elliptical shape and a triangular shape.

13. The automatic parallel adjusting scraper as set forth in claim 10, wherein the hinge part comprises a single body. and a hinge part divided on a medial portion thereof into two parts.

14. The automatic parallel adjusting scraper as set forth in claim 10, wherein the hinge part is divided on a medial portion thereof into two parts.

15. The automatic parallel adjusting scraper as set forth in claim 1, wherein the scraping part is rotatable within an angular range from +5° to −5° with respect to a central axis of the drive-force generating part so as to adjust a parallel status of the scraping part with respect to the light guide plate.

16. The automatic parallel adjusting scraper as set forth in claim 1, wherein pitches between adjacent teeth are successively reduced from one end of the automatic parallel adjusting scraper to the other end thereof.

17. The automatic parallel adjusting scraper as set forth in claim 1, wherein the automatic parallel adjusting scraper comprises a plurality of unit scrapers arranged in a line to form a scraper assembly.

18. The automatic parallel adjusting scraper as set forth in claim 17, wherein the scraper assembly comprises a plurality of groups of unit scrapers;
each group of the unit scrapers has the teeth with a same pitch, the plurality of groups have teeth with different pitches; and
the groups of unit scrapers are arranged in a manner of a sequence from the group of unit scrapers having a largest pitch to the group of unit scrapers having a smallest pitch.

19. An automatic parallel adjusting scraper, comprising a unit scraper comprised of:
a drive-force generating part containing an elastic body therein, the drive-force generating part generating a first step drive force;
a transmitting part coupled to the drive-force generating part so as to be movable, the transmitting part receiving the first step drive force from the drive-force generating part and transmitting the first step drive force;
a hinge part rotatably coupled to the transmitting part, the hinge part receiving the first step drive force from the transmitting part and transmitting the first step drive force;
a scraping part coupled to the hinge part to receive the first step drive force from the hinge part, the scraping part having a plurality of teeth to form grooves of an optical scattering pattern in the light guide plate by the first step drive force, the scraping part being brought into parallel contact with a surface of a light guide plate by a rotation of the hinge part even when the surface of the light guide plate is curved; and
a parallel-adjustment unit horizontally fastened to the transmitting part, the parallel-adjustment unit generating a second step drive force so that the teeth are brought into parallel contact with the curved surface of the light guide plate with a uniform pressure by the second step drive force, the parallel-adjustment unit comprising:
a parallel-adjustment hole formed in a body of the transmitting part, the parallel-adjustment hole being completely open at a first end thereof and partially open at a second end thereof, with an internal thread formed on an inner surface of the parallel-adjustment hole;
an elastic unit located in the parallel-adjustment hole to generate the second step drive force;
a wing bolt engaging with the internal thread of the parallel-adjustment hole, the wing bolt retaining the elastic unit in the parallel-adjustment hole and adjusting a magnitude of the second step drive force; and
a parallel-adjustment rod coupled into the partially open second end of the parallel-adjustment hole so as to be movable, the parallel-adjustment rod transmitting the second step drive force.
